(19) United States
(12) Patent Application Publication
(10) Pub. No.: US 2006/0016557 A1
(43) Pub. Date: Jan. 26, 2006

(54) Insertion of an elongate element into a fibrous substrate

(76) Inventors: Paul Howland, Andover, Hants (GB); Peter M. Henderson, Somerset (GB)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/536,030

(22) PCT Filed: Feb. 12, 2003
(86) PCT No.: PCT/GB03/05196

§ 371 Date: Jun. 28, 2005

(30) Foreign Application Priority Data
Dec. 5, 2002 (GB) 02284248

(51) Int. Cl. B29C 65/00

(52) U.S. Cl. 156/290

(57) ABSTRACT

This invention is directed to improvements in manufacturing substrates, such as paper, incorporating an elongate element (13), to a method of and apparatus for making such paper and to documents made therefrom. The method comprises the steps of depositing fibres onto a moving support surface (10) to form a substrate (14) and introducing an elongate element (13) such that it is at least partially embedded in the substrate (14). Information pertaining to the location of a control feature of the elongate element (18) and the location of the substrate (17) are monitored and provided to a controller (16), which controls the tension of the elongate element (13) as it is introduced into the substrate (14). The location information is used to control the rate at which the elongate element is introduced so that the elongate element control feature is in registration with at least one control feature of the substrate (14).

This invention is directed to improvements in manufacturing substrates, such as paper, incorporating an elongate element, to a method of and apparatus for making such paper and to documents made therefrom.

It is generally known to include elongate security elements in security paper, as a security feature. Such elements can be threads, strips or ribbons of, for example, plastics film, metal foil, metallised plastic, metal wire. These security elements are included in the thickness of security paper to render imitation of documents produced from the paper more difficult. These elements help in the verification of security documents as they render the view of the documents in reflected light different from that in transmitted light. To increase the security provided by the inclusion of such an elongate element, it is also known to endow the element itself with one or more verifiable properties over and above its presence or absence. Such additional properties include magnetic properties, electrical conductivities, the ability to absorb x-rays and fluorescence.

As a further security feature, it has been found to be particularly advantageous to provide windows in one side of the surface of the paper, which expose such elongate elements at spaced locations. Examples of methods of manufacturing such paper incorporating security elements with or without windows are described below. It should be noted that references to “windowed thread paper” include windowed paper incorporating any elongate security element.

EP-A-0059056 describes a method of manufacture of windowed thread paper on a cylinder mould paper-making machine. The technique involves embossing the cylinder mould cover and bringing an impermeable elongate security element into contact with the raised regions of an embossed mould cover, prior to the contact entry point into a vat of aqueous stock. Where the impermeable security element makes intimate contact with the raised regions of the embossing, no fibre deposition can occur. After the paper is fully formed and couched from the cylinder mould cover, the water is extracted from the wet fibre mat and the paper is passed through a drying process. In the finished paper the contact points are present as exposed regions which ultimately form windows, visible in reflected light, on one side of a security or banknote paper.

WO-A-93/08327 describes a method of manufacturing windowed thread paper on a Fourdrinier paper-making machine. A rotating embedment means, with a modified profile for embossing, is used to drive an impermeable elongate security element into draining paper stock, on a Fourdrinier wire. The profile of the embedment means is such that raised portions are provided which remain in contact with the security element during the embedment process. Thus, paper fibres are prevented from collecting between the security element and embedment means, such that the security element is subsequently exposed in windowed regions of paper.

It has also become desirous to incorporate electronic chips, such as IC or RFID chips, into substrates, for security and authentication purposes and these provide a highly versatile security feature which is difficult to counterfeit. Some examples of known security substrates incorporating such chips are described below. WO-A-0007151 describes an electronic switching circuit embedded in security paper. A Carrier frequency input signal is transmitted to the switching circuit for checking authenticity and the circuit emits an output signal representing the authenticity feature in response to the received input signal.

DE-A-19601358 similarly describes a base substrate incorporating an integrated circuit, which is non-detachably and wholly embedded within the substrate. The circuit can be read without contact by the reading device. The circuit can be read capacitively, inductively or by light.

WO-A-0202350 also describes security paper which has a security element which is at least partially exposed on one surface of the paper and which provides at least one visually verifiable optical effect and incorporates an integrated circuit.

However, problems arise in the incorporation of such chips in a fibrous substrate, such as paper, due to their bulk. Such chips typically have a height of 40 microns. When this is embedded into security paper, which typically has a thickness of 190 microns, this results in an increase in the thickness in the area of the chips of 20%. This creates a particular problem in that the smoothness of the surface of the security paper is critical for achieving good printing. The lumpiness of paper containing chips makes printing very difficult. It is therefore vital to know where the chips are to avoid printing on or over them.

It is therefore an object of the present invention to provide a method of manufacturing substrates, such as paper, incorporating an elongate element, that may be the carrier of security features, chips, decorative features or information and the like, which is registered in the machine direction, apparatus for manufacturing such substrates and substrates made thereby.

The invention therefore provides a method of manufacturing a substrate comprising the steps of depositing fibres onto a moving support surface to form a substrate, introducing an elongate element such that it is at least partially embedded in the substrate, monitoring and providing information pertaining to the location of a control feature of the elongate element prior to embedment, monitoring and providing information pertaining to the location of the substrate, controlling the tension of the elongate element as it is introduced into the substrate using the location information to thereby control the rate at which the elongate element is introduced such that the at least one elongate element control feature thereof is in registration with at least one control feature of the substrate.

The invention also provides apparatus for manufacturing a substrate comprising a moving support surface, means for depositing fibres onto the support surface to form a substrate, feed apparatus for introducing an elongate element so that it is at least partially embedded in the substrate, at least one sensor for monitoring and providing information pertaining to the location of at least one primary feature of the elongate element prior to embedment, at least one sensor for monitoring and providing information pertaining to the location of the substrate, said feed apparatus comprising means for controlling the tension of the elongate element as it is introduced into the substrate using the location information to control the rate at which the elongate element is introduced such that the at least one primary feature thereof is in registration with at least one control feature of the substrate.

In addition, the invention provides a substrate in which an elongate element bearing at least one security feature is at least partially embedded, wherein the at least one control feature is in register with at least one control feature of the substrate.

The invention will now be described, by way of example only, with reference to the accompanying drawings in which:

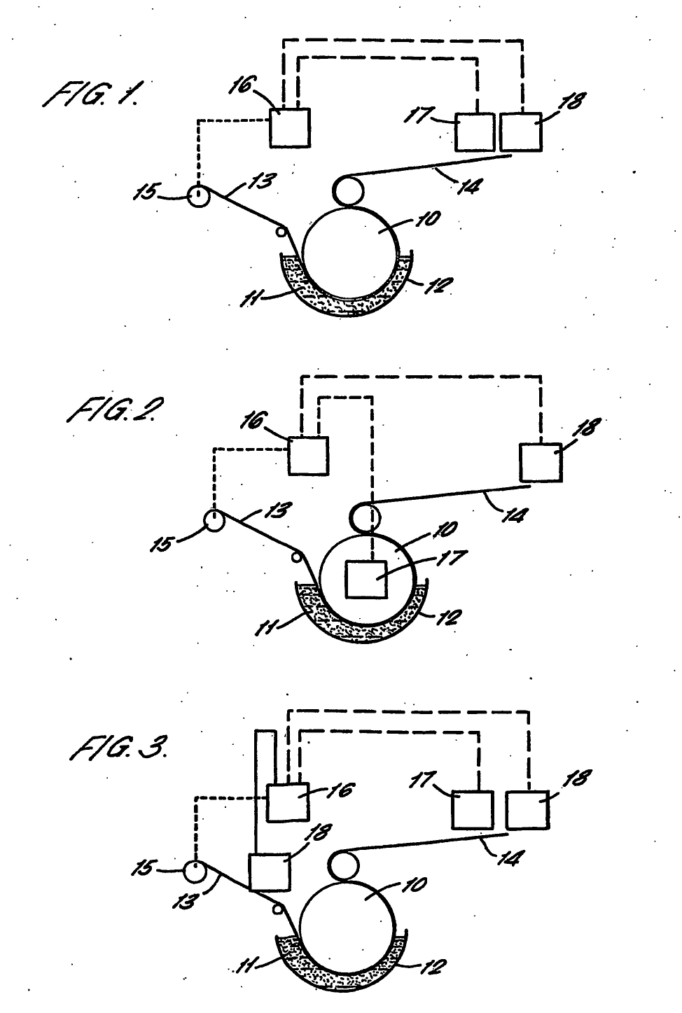

FIG. 1 is a schematic representation of the apparatus used in the method of manufacturing paper according to the present invention; and

FIGS. 2 to 4 are schematic representations of alternative combinations of control strategies used in the method of the present invention.

The method of manufacturing a substrate, such as paper, according to the present invention is illustrated with reference to FIG. 1. A porous support surface, for example in the form of a cylinder mould cover 10, is produced in a known way. If the substrate is to have windows, watermarks or apertures, the mould cover 10 may have portions 12 formed by embossing, such as those described in EP-A-0059056, or other drainage limitation means such as electrotype. The portions 12 are spaced around the mould cover 10 and define the shape of the windows 16 or watermarks formed in the final substrate 15. In this specification the term “window” includes a transparent or translucent region in the substrate of a predefined shape and occurrence.

In a known manner, the cylinder mould cover 10 is rotated in a vat 12 of aqueous fibrous stock 11 as illustrated in FIG. 1, and fibres are continuously deposited thereon in a known manner to form a fibrous mat, as water drains through the mould cover 10. The stock 11 may comprise fibres of natural materials, such as cotton, synthetic fibres or a mixture of both. As the cylinder mould cover 10 rotates, a flexible elongate, usually impermeable, element (or thread) 13, is brought into contact with the cylinder mould cover 10 above or below the level of the stock depending on whether the element is to be wholly embedded or exposed in windows. As the mould cover 10 rotates, the elongate element 13 is introduced into the stock, and is embedded in the fibrous mat as it forms.

This mat, which forms the basis of the substrate, is couched from the cylinder mould cover 10 and is transferred to other processing elements of the cylinder mould machine, during which water is removed by pressing and drying over hot cylinders followed by impregnation with sizing agents, drying in an air float dryer, calendering and finally reeling.

The method of the present invention differs from the prior art methods in that the elongate element 13 is embedded in the substrate 14 in a manner such that a control feature thereof, which may be a security, decorative or other feature, is registered in the machine direction with respect to a control feature of the substrate, which can be a security feature such as a watermark, or a chop mark which is used to guide the cutting of the substrate into sheets. In the latter case the control feature or the security element 13 will ultimately be registered with respect to the edges of the sheet so that its position can be exactly determined. Other substrate control features can also be used. Control marks may also comprise marks especially added for the purpose of thread registration and, like typical chop marks, this could be an electrotype bar. Where such cutting guides provide the control feature, other surface features subsequently applied to the substrate or sheets or documents made therefrom, will be in register with the elongate element. Such surface features include printed information, holograms, patches or indicia formed from liquid crystal materials, thermochromics, UV, IR or luminescent materials and the like.

In order to achieve this, the elongate element 13 must be made of a material which allows it to be stretched by the feed apparatus. The material of the elongate element 13 therefore preferably has a youngs modulus in the range of 0.1 to 10 GPAThe elongate element 13 is provided with at least one control feature which may be, but is not limited to, a decorative feature, a security feature, an information carrying feature or, an electronic chip, such as an IC, RFID, or any other form of electronic chip, mounted thereon. The element 13 may have a feature that is designed purely to facilitate registration by providing the means of detecting the repeat unit of the element 13. Such a feature may be a printed feature, a demetallised feature, a magnetic feature or some other device which will enable the position of the element 13 to be accurately determined. The element 13 may alternatively, or in addition, have one or more other features as control features, such as metallised or demetallised indicia, holograms, luminescence, magnetic coding, printed indicia, photochromic features, thermochromic features, optically variable features or the like. However, these must not significantly interfere with the ability of the elongate element 13 to be stretched. One material from which the elongate element 13 is preferably made is PET or a laminate including polyester. The thickness of the element 13 is preferably in the range of 12 to 200 microns, and more typically in the range of 30 to 70 microns. The width of the element 13 is preferably in the range of 12 to 200 microns, and more typically in the range of 30 to 70 microns. The width of the element 13 is preferably in the range of 0.5 mm to 6 mm and more preferably in the range of 1 mm to 4 mm.

The elongate element 13 is introduced into the substrate 14 under tension. As can be seen from FIG. 1 a spool 15, on which the elongate element 13 is wound, is mounted within the feed apparatus which incorporates a variable braking mechanism to slow the unwinding speed of the spool. 15, or a variable driving mechanism which is variable to positively increase or decrease the unwinding speed. The feed apparatus is controlled by a control unit 16 to which signals are fed from at least a pair of sensors 17,18. One sensor 17 is positioned so as to monitor the location of the control feature(s) of the substrate 14. If the substrate control feature is a watermark, then the sensor 17 may be an optical detector. The other sensor 18 monitors the presence of the control feature(s) on the elongate element 13 before it is embedded in the substrate 14. If the control feature comprises demetallised indicia, then the sensor 18 may be an optical or metal detector. If the control feature is an electronic chip, the sensor 18 may be a chip detector.

The signals from the two sensors 17,18 are used to control the tension applied to the elongate element 13 as it is fed through the machine. The tension applied can cause the element 13 to stretch, or allow it to remain contracted or relaxed, to precisely determine the positioning of the elongate element 13 relative to the substrate 14, as it is fed into the fibrous stock, and therefore the location of the elongate element control features thereon to provide the desired registration.

In addition to embedding the elongate element 13 within the substrate, so that it is partially exposed in windows; or wholly embedded it may also be embedded in the surface of the substrate, so that it is wholly exposed along one surface thereof.

The following examples describe different control strategies all relying on the features described above. In each case the security feature which acts as the control feature of the elongate element 13 has a repeat length which has a single multiple of the control feature of the substrate 14. This ensures that small adjustments to the tension, and thus the length of the elongate element 13, enable its control feature position to be kept constant, in a machine direction relative to the substrate control feature. The variation between the following examples is where the control features are measured and how the multiple lines of features 13 are coordinated.

### EXAMPLE 1

Referring to FIG. 2, the machine direction position of the elongate element 13 and the substrate control feature position are detected at some point shortly after the forming process. It is preferable, from a control point of view, to make this distance as short as possible, but it may be at any point before the drying section. This signal is passed to the control unit 16 which uses an algorithm to determine whether the element 13 is in a leading or trailing position. The control unit 16 then sends a signal to the driven unwind of the spool 16 causing it to brake more or less in order to correct any error in the element 13 to substrate 14 registration.

### EXAMPLE 2

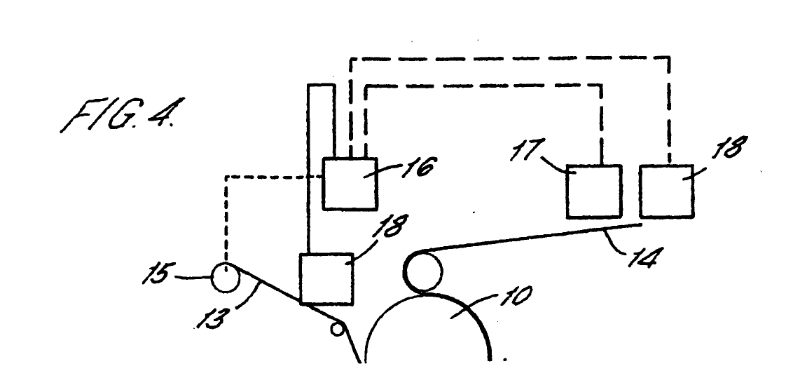

This strategy is shown in FIG. 3 and differs from that described in Example 1 in that the position of substrate 14 is determined by a detector 17 monitoring the position of the-cylinder mould cover 10.

### EXAMPLE 3

This strategy is shown in FIG. 4 and is also essentially the same as example 1 except that an additional elongate element monitor 18 is placed adjacent to the spool 15 monitoring the element unwind. In the previous embodiments each elongate element 13 is controlled independently. In this third embodiment, one elongate element 13 is used as the datum for several or all the others. The position of the “slave” elements 13 relative to the “master” element 13 is monitored and their position corrected so as to ensure that all elements 13 operating are parallel. The second element detector 18 positioned between the spool 15 and cylinder mould cover 10 will be used for all the elements 13, whereas the other detectors 17,18 would only be used for the master.

The combinations described above serve as examples only and do not provide an exhaustive description of alternative detector configurations.

An example of a suitable commercially available machine for use in the present invention is the mark-3-B tear tape dispenser supplied by Applied Unwind Technologies B.V. of the Netherlands. This is a driven thread unwind, which only needs minor modification to enable it to be used with the control unit 16 as described above.

In most commercial papermaking processes, wide webs of paper are manufactured into which a plurality of elongate elements are fed simultaneously. The present invention can be used for embedding multiple elongate elements 13 either by controlling each feed mechanism individually, or controlling one master with slave mechanisms matched to the action of the master.

The method of the present invention can be used with wholly embedded elements 13 or with partially embedded elements 13 in which portions of the element 13 are exposed in windows or apertures at one or both surfaces of the substrate 14. In the latter case the registration desired may be the registration of indicia on the element 13 with the windows or apertures.

As an alternative, indicia on the elongate element 13 may be registered with regard to the anticipated edges of sheets cut from the substrate 14. This may be achieved by detecting a chop mark, as the control feature, or the like on or in the substrate which will subsequently be printed, the printing being in register with the anticipated edges of the sheets located by the notch. As a result the indicia will be in registration with the print.

It should also be noted that the problem of registering security features, including threads, watermarks, and print, applies equally to web printing as well as sheet printing. By using registration control features, possible those used to control the elongate element position, it is possible to ensure that web printed elements, embossings, foils etc, are also applied in register to elongate elements 13 such as threads.

The substrate 14 made in the manner described above can be cut and printed to make all forms of documents, including security documents, such as banknotes, cheques, travellers cheques, identity cards, passports, bonds, security labels, stamps, vouchers etc.

1. A method of manufacturing a substrate (14) comprising the steps of depositing fibres onto a moving support surface (10) to form a substrate (14), introducing an elongate element (13) such that it is at least partially embedded in the substrate (14), monitoring and providing information pertaining to the location of a control feature of the elongate element (13) after embedment of the elongate element (13) in the substrate, monitoring and providing information pertaining to the location of the substrate (14), controlling the tension of the elongate element (13) as it is introduced into the substrate (14) using the location information to thereby control the rate at which the elongate element (13) is introduced such that the at least one elongate element control feature thereof is in registration with at least one control feature of the substrate (14).

2. A method as claimed in claim 1 in which the location of the at least one control feature of the substrate (14) is monitored after its formation.

3. A method as claimed in claim 1 in which the at least one substrate control feature comprises windows or apertures, said support surface (10) having spaced portions (12) which prevent substantial deposition of fibres at those portions to form said windows (16) at spaced locations in at least one surface of the substrate (14), the deposition of fibres being carried out in such a manner that as fibres are deposited onto the support surface (10), the elongate element (13) is incorporated in the substrate with element control features exposed in, and in register with, said windows (16).

4. A method as claimed in claim 3 in which windows (16) or apertures are formed in both surfaces of the substrate.

5. A method as claimed in claim 1 or in which the elongate element (13) is wholly embedded within the substrate (14).

6. A method as claimed in claim 1 in which the at least one control feature of the substrate (14) is a watermark and one or more control features of the elongate element (13) are registered with respect to the watermark.

7. A method as claimed in claim 1 in which at least one control feature of the substrate comprises indication means for guiding the subsequent cutting of the substrate (14) into discrete sheets, and one or more control features of the elongate element (13) are registered with respect to said indication means.

8. A method as claimed in claim 7 in which, after formation, the substrate (14) is provided with at least one surface feature in registration with said indication means such that one or more control features of the elongate element (13) are registered with respect to said at least one surface feature.

9. A method as claimed in claim 8 in which the at least one surface feature comprises printed information.

10. A method as claimed in claim 8 in which at least one of said surface features comprises at least one security feature applied to the surface of the substrate (14).

11. A method as claimed in claim 8 in which at least one surface feature comprises a hologram.

12. A method as claimed in claim 1 in which the at least one control feature of the elongate element (13) comprises metallised or demetallised indicia.

13. A method as claimed in claim 1 in which at least one control feature of the elongate element (13) comprises an electronic chip.

14. A method as claimed in claim 1 in which at least one control feature of the elongate element (13) comprises a hologram.

15. A method as claimed in claim 1 in which at least one control feature of the elongate element (13) comprises a magnetic, luminescent, printed, photochromic, thermochromic, and or an optically variable feature.

16. A method as claimed in claim 1 in which the elongate element (13) is made of a material having a Youngs Modulus in the range of 0.1 to 10 Gpa.

17. Apparatus for manufacturing a substrate (14) comprising a moving support surface (10), means for depositing fibres onto the support surface (10) to form a substrate (14), feed apparatus for introducing an elongate element (13) so that it is at least partially embedded in the substrate (14), at least one sensor (18) for monitoring and providing information pertaining to the location of at least one primary feature of the elongate element after embedment of the elongate element in the substrate, at least one sensor (17) for monitoring and providing information pertaining to the location of the substrate (14), said feed apparatus comprising means for controlling the tension of the elongate element (13) as it is introduced into the substrate (14) using the location information to control the rate at which the elongate element (13) is introduced such that the at least one primary feature thereof is in registration with at least one control feature of the substrate (14).

18. Apparatus as claimed in claim 17 in which the means for controlling the tension of the elongate element comprises a variable braking device for slowing the unwinding speed of a spool on which the elongate element is wound.

19. Apparatus as claimed in claim 17 in which the means for controlling the tension of the elongate element (13) comprises a variable driving mechanism which increases or decreases the unwinding speed of a spool (15) on which the elongate element (13) is wound.

20. A substrate (14), provided with at least one control feature, said substrate having at least partially embedded herein an elongate element, said elongate element being provided with at least another control feature, the control feature of the elongate element being such that its position is monitorable, wherein the control feature of the elongate element is in register with the control feature of the substrate (14).

21. A substrate (14) as claimed in claim 20 made by the method claimed in claim 1.

22. A substrate (14) as claimed in claim 20 in which at least one elongate element control feature comprises metallised or demetallised indicia.

23. A substrate (14) as claimed in claim 20 in which at least one elongate element control feature comprises a hologram, a magnetic, luminescent, printed, photochromic, thermochromic and/or an optically variable feature.

24. A substrate (14) as claimed in claim 20 in which at least one substrate control feature comprises windows (16) in one or both surfaces of the substrate.

25. A substrate (14) as claimed in claim 20 in which at least one substrate control feature comprises a watermark.

26. A substrate (14) as claimed in claim 20 in which the at least one elongate element control feature is in register with printed information subsequently applied to a surface of said substrate (14).

27. A document made from the substrate (14) of claim 20.

28. A security document made from the substrate (14) of claim 20 in which at least one of the control features is a security feature.

29. A security document as claimed in claim 28 in which the security document comprises a bank note, passport, voucher, certificate, security bond, telephone card, smart card, bank card, or the like.
